(19) United States
(12) Patent Application Publication
(10) Pub. No.: US 2003/0110257 A1
(43) Pub. Date: Jun. 12, 2003

(54) Method for performing a load distribution between session initiation protocol servers within an intra domain

(76) Inventors: Wook Hyun, Daejeon (KR); Mi Young Huh, Daejeon (KR); Shin Gak Kang, Daejeon (KR)

Correspondence Address: JACOBSON HOLMAN, PROFESSIONAL LIMITED LIABILITY COMPANY, 400 Seventh Street, N.W., Washington, DC, 20004, US

(21) Appl. No.: 10/314,940

(22) Filed: Dec. 10, 2002

(30) Foreign Application Priority Data
Dec. 11, 2001 (KR) 2001-78193

(51) Int. Cl. G06F 15/173

(52) U.S. Cl. 709/224

(57) ABSTRACT

A load distribution is performed between session initiation protocol (SIP) servers in an intra domain.

By employing a distribution process and a function-based server characterization, loads of a single representative proxy can be effectively distributed and a call processing capacity can be maximized while maintaining compatibility with existing proxies.

### FIELD OF THE INVENTION

The present invention relates to a method for performing a load distribution between session initiation protocol (SIP) servers in an intra domain; and, more particularly, to a method for performing the load distribution between the SIP servers in the intra domain by employing a DB search function and an inter-server load distribution technique, thereby allowing for an effective and fast processing of a large-capacity SIP traffic.

### BACKGROUND OF THE INVENTION

Currently, a SIP standard of IETF RFC2543 provides a user address retrieving function using a redirect server as a way for processing a large-capacity call within a single domain and distributing a load of a proxy server.

There are two methods for processing a call that arrives at a certain domain: one is a batch processing technique employing a single proxy and the other is a function distribution technique utilizing a redirect server.

While the batch processing technique features a structural simplicity and a high cost effectiveness due to its use of a single proxy, it also has many disadvantages in that it is unable to process a large-capacity traffic and provide the service to a number of users. Particularly, the batch processing technique has a critical drawback in that the efficiency of the technique is deteriorated as the size of a user address DB increases.

In the function distribution technique using the redirect server, roles are assigned in a manner that a proxy is entrusted with status management and call transmission while the re-direct server takes charge of retrieving a user address. By assigning a DB management routine, which frequently causes a load of a server and is comparatively time-consuming, to the redirect server and allowing the proxy solely to deal with the call management, a service-processing rate can be greatly increased.

Conventionally, the function distribution technique has been preferred to the batch type processing technique in processing a large-capacity SIP traffic. However, the function distribution technique has defects in that a great amount of time is required and a load of the proxy may be increased since the technique involves reprocessing a redirect message of a ‘3xx’ type. Further, it is inevitable in this technique to employ various methods which are not defined by the standard in order to operate a plurality of servers at the same time.

### SUMMARY OF THE INVENTION

It is, therefore, an object of the present invention to provide a method for performing a load distribution between SIP servers in an intra domain by combining a DB search function with an inter-server load distribution function while maintaining compatibility and expansibility with existing proxy servers, thereby improving service efficiency while operating a plurality of servers at the same time.

In accordance with a preferred embodiment of the present invention, there is provided a method for performing a load distribution between SIP servers in an intra domain having a SIP load distributor (SLD) server for processing a SIP request by conducting a DB search function and a load distribution function, the method comprising the steps of:

(a) transmitting the SIP request from a representative proxy of the intra domain to the SLD server;

(b) retrieving a user address for the SIP request and adding the retrieved user address to the SIP request;

(c) searching for a least loaded proxy in a load management table and applies a load increment required to process the SIP request to a load record for the least loaded proxy in the load management table; and

(d) sending the SIP request to the least loaded proxy.

In accordance with another preferred embodiment of the present invention, there is provided a method for performing a load distribution between SIP servers in an intra domain having a SLD server for processing a SIP response by conducting a DB search function and a load distribution function, the method comprising the steps of:

(a) analyzing a response code of the SIP response transmitted from an internal proxy to the SLD server;

(b) applying to a load management table a load decrement of the internal proxy according to a transmission of a final response if the response code is found to be the final response and transmitting the SIP response to the representative proxy;

(c) generating a new SIP request if the response code is determined as a response for notifying incompatibility with the internal proxy, sending the newly generated SIP request to the internal proxy and applying a load increment of the internal proxy to the load management table of the SLD server; and

(d) transmitting the SIP response to the representative proxy if the response code is found to be an informational response.

### BRIEF DESCRIPTION OF THE DRAWINGS

The above and other objects and features of the present invention will become apparent from the following description of preferred embodiments given in conjunction with the accompanying drawings, in which:

FIG. 1 is a flowchart of a load distribution process between SIP servers performed at a time when a SIP request is received in accordance with a first embodiment of the present invention;

FIG. 2 provides a flowchart of a load distribution process between SIP servers performed at a time when a SIP response is received in accordance with a second preferred embodiment of the present invention;

FIG. 3 describes a load distribution process between SIP servers in an intra domain in accordance with a third embodiment of the present invention, wherein a SIP request transferred through a representative proxy is delivered to a user address by a SIP Load Distributor (SLD) server;

FIG. 4 illustrates a load distribution process between SIP servers in an intra domain in accordance with a fourth embodiment of the present invention, wherein a final response transferred through an internal proxy is delivered to a representative proxy by the SLD server;

FIG. 5 explains a load distribution process between SIP servers in an intra domain in accordance with a fifth embodiment of the present invention, wherein an informational response transferred through an internal proxy is delievered to a representative proxy by the SLD server; and

FIG. 6 demonstrates a load distribution process between SIP servers in an intra domain in accordance with a sixth embodiment of the present invention, wherein a new SIP request is transmitted to an internal proxy after a Bad Extension response delivered from the internal proxy is processed by the SLD server.

### DETAILED DESCRIPTION OF PREFERRED EMBODIMENTS

The technical essence of the present invention resides in the fact that a large-capacity SIP traffic can be processed as speedily as possible by employing a DB management unit (a re-direct server) and an inter-server load balancing technique (a load distribution technique) while maintaining compatibility and expansibility with existing proxies.

Specifically, the present invention prevents a rush of call requests into a single server by distributing a load to a plurality of servers. By employing a SLD (SIP load distribution) server which operates to search a DB and manage loads between servers and a representative proxy server which is solely in charge of managing and processing a call request, the present invention provides a method for processing a large-capacity call as fast as possible.

Assume that servers in an intra domain are configured as follows.

First, a representative proxy transfers a received call request to a SLD (SIP load distribution) server. The SLD server then adds to the call request a via header designating the SLD server in order to allow a SIP response corresponding to the SIP request to pass through the SLD server later.

Secondly, the SIP response received at the SLD server is sent to the representative proxy server based on an address of the representative proxy recorded in the via header thereof.

Thirdly, the SLD server is set to know feature information and address information of internal proxies.

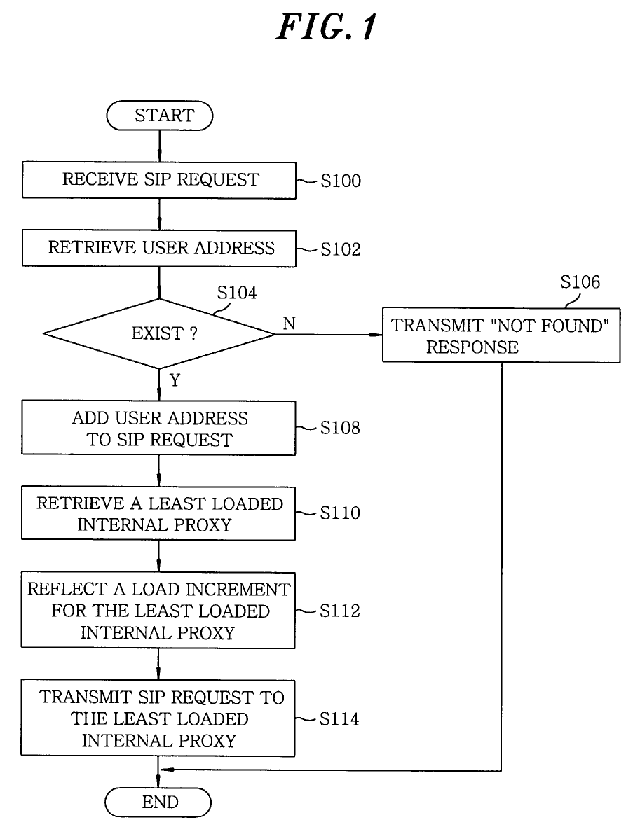

Referring to FIG. 1, there is provided a flowchart of a load distribution process performed between SIP servers at a time when a SIP request is received in accordance with a first embodiment of the present invention.

First, the representative proxy server in the intra domain determines whether the SIP request has been received thereat and if so, the representative proxy server adds to the received SIP request a via header describing an address of the representative proxy server and, then, sends the SIP request to the SLD server (Step 100).

The SLD server searches for a user address corresponding to the SIP request by checking a registry DB corresponding to an address recorded in the SIP request (Step 102) and, then, determines whether there exists a search result (Step 104).

If the user address is not found in the step 104, the SLD server generates a response of ‘404’ type, e.g., a “Not found” response and transfers the generated response to the representative proxy.

If the user address is found in the step 104, however, the SLD server proceeds to add the user address to the SIP request (Step 108). To be more specific, the SLD server first adds to the SIP request a Proxy-Require header having a “PreLoadedContact” header (Proxy-Require: PreLoadedContact). Then, the SLD server writes the retrieved user address in the “PreLoadedContact” header and also adds thereto a via header designating the SLD server itself. By adding the via header specifying the SLD server, the SIP response corresponding to the SIP request becomes to pass through the SLD server later.

Then, the SLD server searches a load management table to retrieve a least loaded internal proxy (Step 110).

Thereafter, the SLD server adds to a load record for the least loaded internal proxy a load increment A required to process the SIP request (Step 112).

Finally, the SLD server transmits the SIP request to the least loaded internal proxy and the process shown in FIG. 1 is terminated (Step 114).

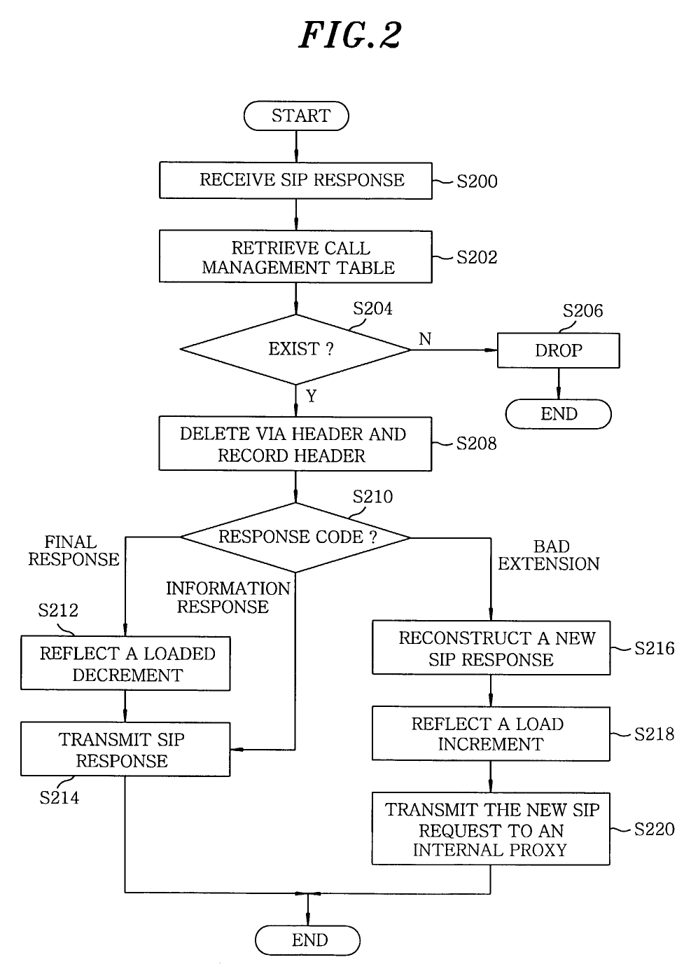

Referring to FIG. 2, there is provided a flowchart of a load distribution process performed between the SIP servers at a time when the SIP response is received.

First, the SLD server receives the SIP response from an internal proxy (Step 200). Then, the SLD searches its call management table (Step 202) and determines whether there exists a search result (Step 204).

If it is found in the step 204 that there exists the search result, the SLD server proceeds to delete from the SIP response the via header specifying the SLD server and a record route header (Step 208) and, then, analyzes a response code of the SIP response (Step 210).

If it is determined in the step 210 that the received SIP response is a final response, the SLD server applies a load decrement A, which is resulted from the transmission of the final response, to a load record for the internal proxy that has transmitted the final response (Step 212), the load related record existing in the load management table of the SLD server.

Then, the SLD server transfers the SIP response to the representative proxy (Step 214).

If it is found in the step 210, however, that the received response is not the final response but a response of ‘420’ type, e.g., a “Bad Extension” response, the SLD server generates a new SIP request message (Step 216). It is preferable that the new SIP request is generated by adding to the first received SIP request a via header specifying the SLD server. Afterwards, the SLD server applies a load increment B, which is required to process the new SIP request, to the load management table corresponding to the internal proxy (Step 218). Thereafter, the SLD server transmits the new SIP request to the internal proxy (Step 220).

If it is found in the step 210, however, that the received response is neither the final response nor the “420” type response but just an informational response, the SLD server transmits the SIP response to the representative proxy.

In the meanwhile, the internal proxy internally operates as follows at a time when it receives from the SLD server the SIP request having the “PreLoadedContact” header.

In case the internal proxy supports the “PreLoadedContact” header, the internal proxy deletes the “PreLoadedContact” header and the proxy request header from the SIP request and adds thereto a via header specifying the internal proxy itself. Then, the internal proxy sends the SIP request to a user address specified in the “PreLoadedContact” header. In case it supports forking, on the other hand, the internal proxy transmits the SIP request to user addresses specified in the “PreLoadedContact” header simultaneously or in regular sequence.

If the internal proxy does not support the “PreLoadedContact” header, on the other hand, the internal proxy transfers to the SLD server a response message of ‘420 type’, e.g., a “Not supported” response.

Hereinafter, the process for performing the load distribution between the SIP servers in the intra domain will be described in further detail with respect to a message transfer process in accordance with preferred embodiments of the present invention.

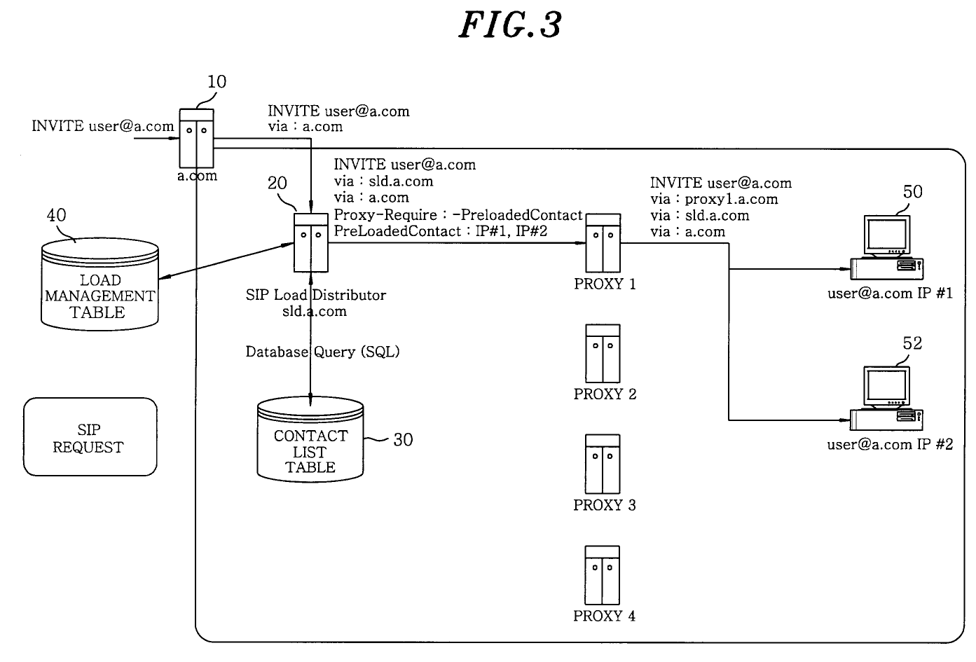

Referring to FIG. 3, there is described a process for performing a load distribution between SIP servers in an intra domain in accordance with a third embodiment of the present invention, wherein a SIP response received at the representative proxy server is delivered to a user address (UA) by an SLD server.

As shown in FIG. 3, the SIP request received at a representative proxy (a.com) 10 is transmitted to a SLD server 20 with a via header specifying the representative proxy added thereto. At this time, message transfer information is as follows:

INVITE user@a.com

Via: a.com

Via: caller_IP:caller_Port

After receiving the SIP request, the SLD server 20 searches a contact list table 30 to retrieve a user address for user@a.com recorded in the SIP request, as described in FIG. 1. Then, the SLD server adds the search result to the SIP request in the form of a “PreLoadedContact” header. More specifically, the SLD server adds to the SIP request a Proxy-Require header containing “PreLoadedContact” information and a via header designating the SLD server.

Then, the SLD server 20 searches a load management table 40 therein to find a least loaded internal proxy and if the least loaded internal proxy is found, the SLD server 20 adds to a load record for the least loaded internal proxy a load increment A which is required to process the SIP request. Thereafter, the SLD server 20 sends the SIP request to the least loaded internal proxy.

At this time, the SIP request includes information as follows.

INVITE user@a.com

Proxy-Require: PreLoadedContact

PreLoadedContact: IP1, IP2

Via: sld.a.com

Via: a.com

Via: caller_IP:caller_Port

Since the “PreLoadedContact” header is included in the SIP request, the internal proxy is allowed to transmit the SIP request to the user address specified in the “PreLooadedContact” header through a forking process without the need of performing a DB search process for retrieving the user address.

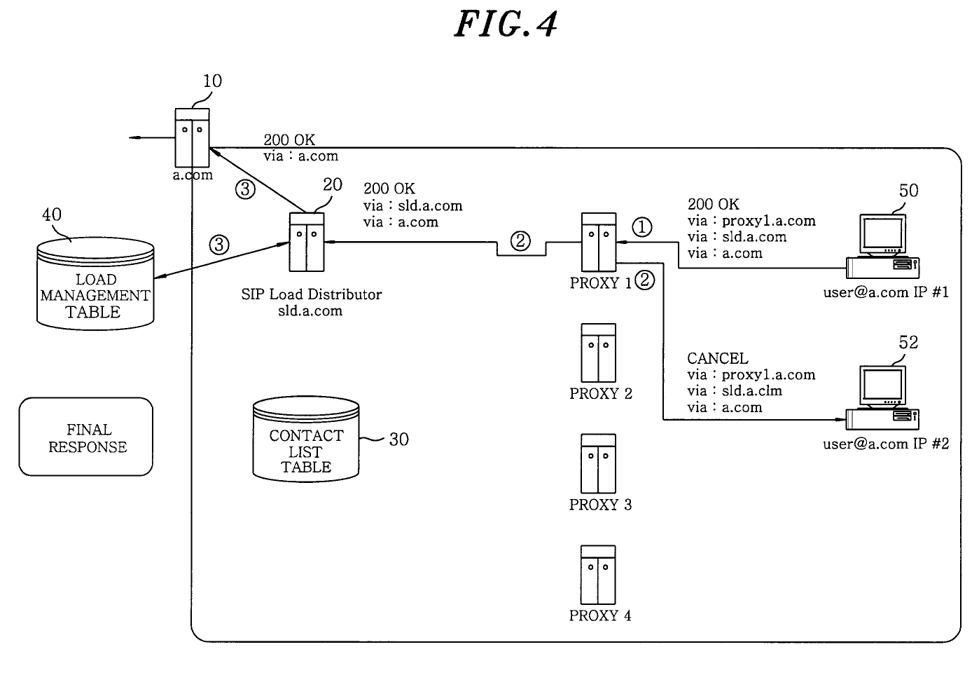

FIG. 4 illustrates a process for performing a load distribution between the SIP servers in the intra domain in accordance with a fourth embodiment of the present invention, wherein the SLD server transfers the final response received through the internal proxy to the representative proxy.

If a response of ‘200’ type, i.e., the final response for the SIP request, which has been sent to many a user address through the forking process, is transmitted from a certain user address 50 to an internal proxy (proxy1.a.com), the internal proxy (proxy1.a.com) immediately delivers the received final response to the SLD server 20 and, simultaneously transmits a cancel message to the rest of the user addresses, e.g., a user address 52 shown in FIG. 4. The final response transmitted to the SLD server 20 includes the following information.

200 OK

Via: sld.a.com

Via: a.com

Via: caller_IP:caller_Port

After receiving the final response, the SLD server 20 applies a load decrement A according to the generation of the final response to the load management table 40 for the internal proxy and records that the load of the internal proxy has been lowered. Thereafter, the via header designating the SLD server is deleted from the final response and the via header removed final response is delivered to the representative proxy. The final response sent to the SLD server includes the following information.

200 OK

Via: caller_IP:caller_Port

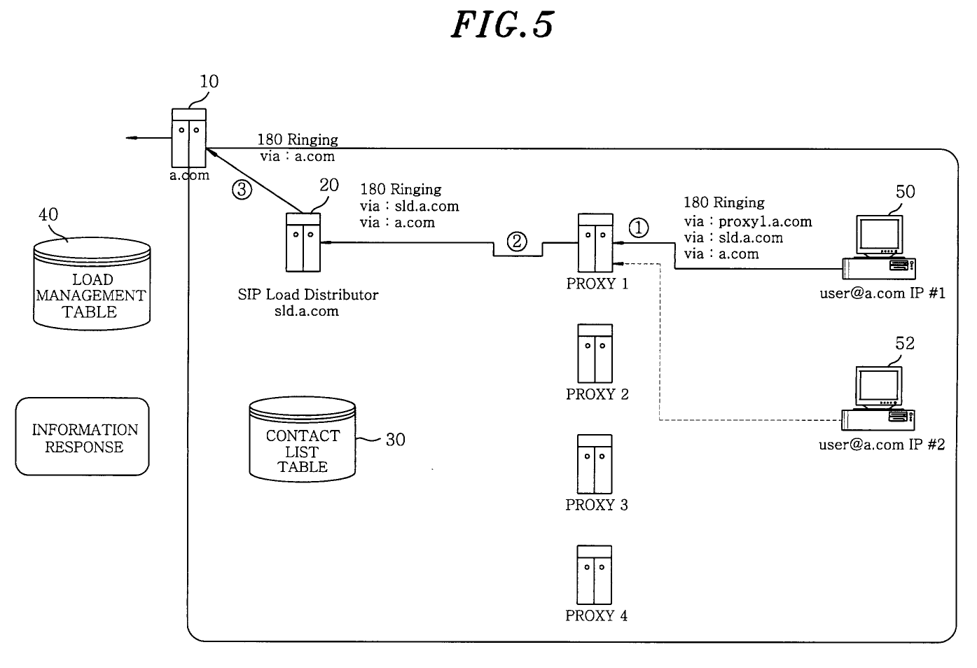

Referring to FIG. 5, there is provided a drawing for describing a load distribution process between the SIP server in the intra domain in accordance with a fifth embodiment of the present invention, wherein an information response is transmitted to the representative proxy by the SLD server.

If the informational response is transferred from the user address 50 to the internal proxy (proxy1.a.com), the informational response referring to a response which is not the final response, e.g., a ring response such as a ‘180’ type message, the internal proxy (proxy1.a.com) removes from the informational response a via header designating the internal proxy and, then, sends the informational response to the SLD server 20 in no time. The SLD server deletes a via header representing the SLD server from the received informational response and, then, transmits the informational response to the representative proxy (a.com) 10. Then, the representative proxy 10 also removes from the received information response a via header indicating the representative proxy itself and sends the via header removed information response to a higher-ranking server (not shown).

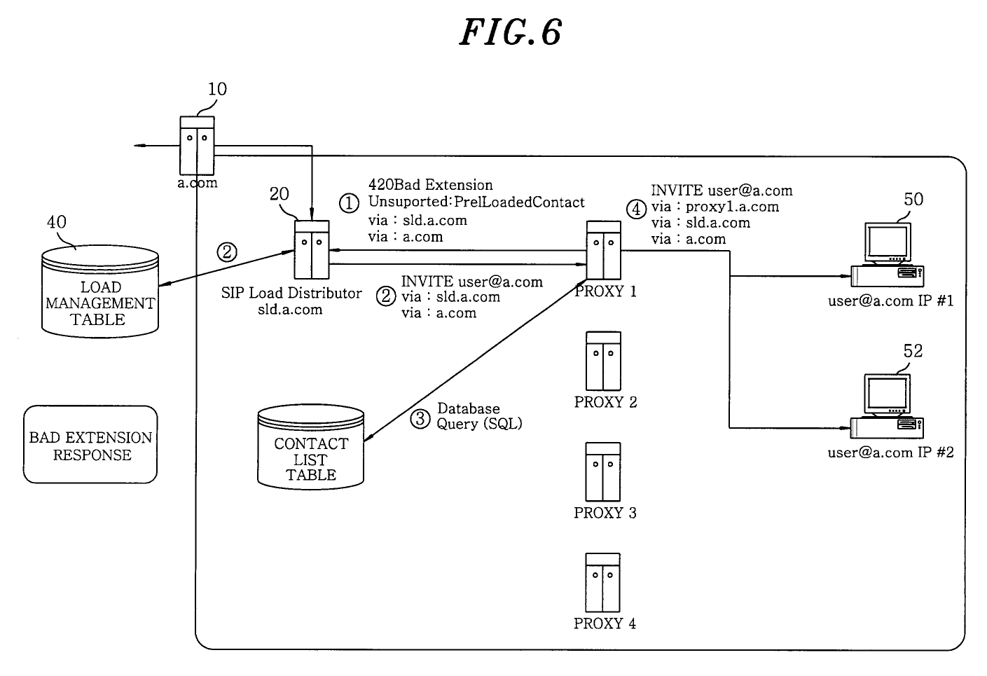

FIG. 6 illustrates a load distribution process between the SIP servers in the intra domain in accordance with the sixth embodiment of the present invention, which drawing specifically describes a case where the SLD server receives a “Bad Extension” response.

In case the internal proxy does not support the “PreLoadedContact” server, the internal proxy transmits to the SLD server a response of ‘420’ type such as the “Bad Extension” response. The SLD server does not adds a newly defined “PreLoadedContact” header to the originally received SIP request but just adds thereto a via header designating the SLD server and sends the SIP request to the internal proxy again. The internal proxy (proxy1.a.com) directly accesses the contact list table 30 to retrieve user addresses for ‘user@a.com’ and performs the rest of the process.

While the invention has been shown and described with respect to preferred embodiments, it will be understood by those skilled in the art that various changes and modifications may be made without departing from the spirit and scope of the invention as defined in the following claims.

What is claimed is:

1. A method for performing a load distribution between SIP servers in an intra domain having a SIP load distributor (SLD) server for processing a SIP request by conducting a DB search function and a load distribution function, the method comprising the steps of:
(a) transmitting the SIP request from a representative proxy of the intra domain to the SLD server;
(b) retrieving a user address for the SIP request and adding the retrieved user address to the SIP request;
(c) searching for a least loaded proxy in a load management table and applies a load increment required to process the SIP request to a load record for the least loaded proxy in the load management table; and
(d) sending the SIP request to the least loaded proxy.

2. The method of claim 1, wherein the step (b) includes the step of transmitting a ‘not found’ response to the representative proxy if there exists no user address.

3. The method of claim 1, wherein the step (c) includes the step of adding a Proxy-Require header specifying a “PreLoadedContact” header, writing a user address in the “PreLoadedContact header” and adding a via adder designating the SLD server.

4. A method for performing a load distribution between SIP servers in an intra domain having a SLD server for processing a SIP response by conducting a DB search function and a load distribution function, the method comprising the steps of:
(a) analyzing a response code of the SIP response transmitted from an internal proxy to the SLD server;
(c) applying to a load management table a load decrement of the internal proxy according to a transmission of a final response if the response code is found to be the final response and transmitting the SIP response to the representative proxy;
(c) generating a new SIP request if the response code is determined as a response for notifying incompatibility with the internal proxy, sending the newly generated SIP request to the internal proxy and applying a load increment of the internal proxy to the load management table of the SLD server; and
(d) transmitting the SIP response to the representative proxy if the response code is found to be an informational response.

5. The method of claim 4, wherein the step (b) includes the step of searching a call management table if the SIP response is received at the SLD server from the representative proxy and deleting from the SIP response a via header and a record route header if there exist a search result.

6. The method of claim 4, wherein the response for notifying the incompatibility with the internal proxy is a “Bad Extension” response.
